(19) United States
(12) Patent Application Publication
(10) Pub. No.: US 2007/0051843 A1
(43) Pub. Date: Mar. 8, 2007

(54) Apparatus and method for combining a plurality of printing material webs

(75) Inventor: Klaus Theilacker, Friedberg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/516,079

(22) Filed: Sep. 6, 2006

(30) Foreign Application Priority Data
Sep. 7, 2005 (DE) 10 2005 042 437.6

(51) Int. Cl. B65H 39/16; B41F 13/58; B65H 39/02

(52) U.S. Cl. 242/444.1

(57) ABSTRACT

An apparatus and method for combining a plurality of printing material webs to form a multi-layer strand is disclosed. In an apparatus for combining a plurality of printing material webs to form a multi-layer strand, having a wire guide formed by deflection rolls assigned to the individual printing material webs, it is possible to achieve reliable tensioning of the former and top webs and to ensure high accuracy in that the two deflection rolls forming the outlet from the wire guide can be driven.

This application claims the priority of German Patent Document No. 10 2005 042 437.6, filed Sept. 7, 2005, the disclosure of which is expressly incorporated by reference herein.

### BACKGROUND AND SUMMARY OF THE INVENTION

The invention relates to an apparatus and method for combining a plurality of printing material webs to form a multi-layer strand, having a wire guide formed by deflection rolls assigned to the individual printing material webs.

Experience shows that what are known as the former web and top web run into the folding former with a lower tension than the intermediate webs, that is to say the former web and the top web tend to be loose upstream of the folding former. This phenomenon becomes more severe the thicker the strand is. The aforementioned tendency can be made even more severe by the former web and the top web being printed in many colors, as opposed to the intermediate webs, and accordingly stretching more extensively than the intermediate webs, so that their web tension can fall still further. The excessively low web tension of the former web and the top web can lead to these webs running astray in the region between the last printing unit and the folder, which can lead to register defects.

On this basis, it is therefore the object of the present invention to improve an apparatus of the type mentioned at the beginning with simple and cost-effective means in such a way that a reliable web tension of a former web and top web is ensured.

According to the invention, this object is achieved in that the two deflection rolls forming the outlet from the wire guide can be driven.

These measures ensure that the former and top web guided over the lower wire guide rolls that can be driven are pulled into the wire guide more forcefully than the intermediate webs. This ensures that these webs, irrespective of the pulling group arranged downstream, are given such a high web tension that they can be led from the last printing unit to the folder in register without running astray.

Advantageous refinements and expedient developments of the primary measures are specified in the description and drawing.

For example, a particularly high effect of the drive of the lower wire guide rolls can be achieved if these are wrapped around by the respectively associated web over an angle of at least 60°, preferably 90°. Because of this comparatively high wrap, the result is a reliable transmission of force from the driven deflection rolls to the respectively associated web.

A further expedient measure can consist in the deflection rolls that can be driven having a drive connection to adjacent units that can be driven. In this way, dedicated drives can be obviated, which accordingly leads to a particularly cost-effective design.

Advantageously, the two deflection rolls that can be driven, forming the outlet from the wire guide, can be offset in relation to each other in the running direction of the strand and, transversely thereto, can be arranged to overlap each other slightly. In this way, approximately S-shaped strand guidance is achieved. This ensures that the air enclosed between the webs is reliably pressed out of the strand, which can improve the accuracy when running over the folding former.

Further advantageous refinements and expedient developments of the primary measures can be gathered in more detail from the following exemplary description by using the drawing.

### BRIEF DESCRIPTION OF THE DRAWINGS

FIG. 1 shows a partial view of a folder upper part having a folding former and an inlet device which is assigned to the former.

### DETAILED DESCRIPTION OF THE DRAWINGS

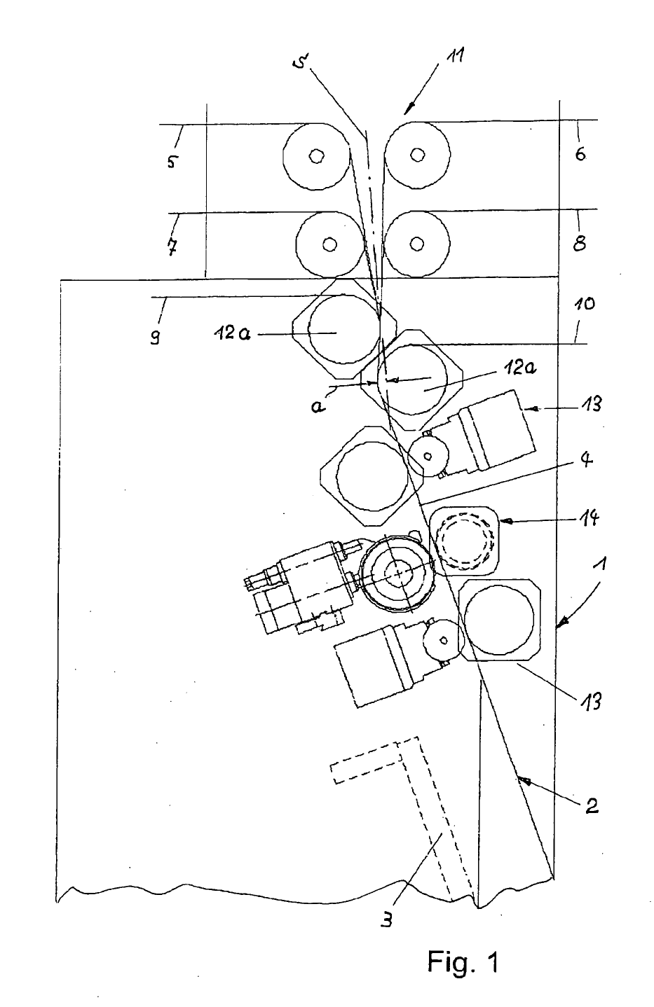

FIG. 1 shows the upper region of a folder structure 1. As a rule, a plurality of folding formers arc provided over the width of the folder structure 1, of which one folding former 2 is visible in the drawing. The folding formers are normally accommodated such that they can be adjusted on a crossmember 3 that is continuous over the width of the folder structure

A strand 4 formed by a plurality of webs placed on one another is supplied to the folding former 2. The aforementioned webs can be printing material webs coming from upstream press units. In the example illustrated, six printing material webs 5 to 10 are combined to form a six-layer strand 4. The lowest web of the strand 4, which slides on the folding former 2, is designated the former web, and the opposite, uppermost web is designated the top web. The webs lying in between are called intermediate webs.

In order to combine the printing material webs 5 to 10, what is known as a wire guide 11 is provided upstream of the folding former 2. The wire guide 11 comprises two mutually opposite rows of deflection rolls arranged above each other, over which in each case an associated printing material web 5 or 6 or 7, or 8 or 9, or 10 is deflected downwards. In the example illustrated, as already mentioned, a 6-layer strand is formed. Accordingly,-the wire guide 11 comprises six deflection rolls.

As a result of their high speed, the printing material webs 5 to 10 running into the wire guide 11 entrain surrounding air with them, so that in each case a laminar air flow forms on the upper side and underside of the webs and, as the webs run together, has to be pressed out of the strand 4 in order to avoid undesired air inclusions between the webs. To this end, deflection rolls are provided in the region of the outlet from the wire guide 11 and are arranged in such a way that they deflect the strand 4 transversely with respect to the running direction of the strand 4 as compared with rectilinear strand guidance indicated in the drawing by a dash-dotted line S. In this way, a certain amount of wrap around the relevant deflection rolls is effected, which leads to the air being pressed out of the strand 4. To this end, deflection rolls arranged downstream of the wire guide 11 can be provided. In the example illustrated, the two lowest deflection rolls 12a of the wire guide 11 are used for this purpose, which results in a particularly compact arrangement.

As a rule, two deflection rolls 12a provided in order to form an S-shaped strand guide are sufficient. However, it is also conceivable, in order to bring about more frequent deflection of the strand, also to provide a plurality of deflection rolls 12a involved in this process. In any case, the deflection rolls 12a involved in the deflection of the strand as compared with rectilinear web guidance are offset in relation to one another in the running direction of the strand 4 and, transversely thereto, are arranged to overlap one another slightly, as indicated at reference symbol “a” in the drawing. The dash-dotted line S indicating rectilinear strand guidance touches the upper deflection roll 12a and intersects the lower deflection roll 12a, the dimension “a” signifying the perpendicular distance from the circumference.

The mutual overlap of the deflection rolls 12a effecting the S-shaped strand guidance must be only comparatively small, in order to avoid resultant speed differences between the innermost and the outermost webs of the strand 4 because of the curvature of the wrap. This overlap must be only so slight such that the friction between the webs is sufficient to prevent speed changes. For this purpose, the mutually overlapping deflection rolls 12a are arranged in such a way that the wrap angle over which they are wrapped around by the strand 4 is not greater than 15°, and preferably amounts to 10°. On the other hand, this wrap angle must also not be too small, in order to press out the air reliably. This wrap angle should therefore be no smaller than 5°.

The former web, here the printing material web 9, and the top web, here the printing material web 10, are normally printed in many colors, whereas the intermediate webs are frequently printed in only one color. Webs printed in many colors stretch more than webs printed in only one color, however, which can lead to a fall in the web tension of the former web and top web, which can intensify the above-mentioned tendency to speed differences. In order to counteract this, the deflection rolls 12a assigned to the former and top webs can be driven. In the example illustrated, the two lower deflection rolls 12a of the wire guide 11 can accordingly be driven. In this way, it is possible to increase the web tension of the former and top web in the desired manner.

The deflection rolls 12a that can be driven are wrapped around by the respectively associated printing material web 9 or 10 over an angle of at least 60°, preferably of 90°.

The deflection rolls 12a that can be driven can be provided with associated individual drive motors. The deflection rolls 12a that can be driven are advantageously connected by means of a belt drive, not specifically illustrated, to a common drive motor or, in a manner that is particularly to be preferred, together with the adjacent units that can likewise be driven, are connected to a common drive motor. In the example illustrated, between the outlet from the wire guide 11 and the folding former 2, two pulling groups 13 and a cutting group 14 arranged in between are provided. These are likewise units that can be driven. The deflection rolls 12a that can be driven can therefore expediently have a drive connection to a common drive motor by means of a belt drive, together with the pulling groups 13 and the cutting group 14.

In any case, however, it may be expedient if the drive of the two deflection rolls 12a that can be driven can have its surface speed varied with respect to the adjacent pulling groups. In the case of a common drive, this can be brought about, for example, by means of a suitable intermediate gear.

List of reference symbols:
1 Folder structure
2 Folding former
3 Crossmember
4 Strand
5-10 Printing material webs
11 Wire guide
12a Deflection rolls
Pulling groups
Cutting group

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for combining a plurality of printing material webs to form a multi-layer strand, having a wire guide formed by deflection rolls assigned to the individual printing material webs, wherein two deflection rolls forming an outlet from the wire guide are driveable.

2. The apparatus according to claim 1, wherein the driveable deflection rolls have a drive connection to adjacent driveable units.

3. The apparatus according to claim 1, wherein the driveable deflection rolls are driven by means of a belt drive.

4. The apparatus according to claim 1, wherein the driveable deflection rolls are wrapped around by a respective assigned printing material web over an angle of at least 60°.

5. The apparatus according to claim 4, wherein the driveable deflection rolls are wrapped around by the respective assigned printing material web over an angle of 90°.

6. The apparatus according to claim 1, wherein the two deflection rolls forming the outlet from the wire guide are offset in relation to each other in a running direction of the strand and, transversely thereto, are arranged to overlap each other slightly.

7. The apparatus according to claim 1, wherein a surface speed of the driveable deflection rolls is variable with respect to a surface speed of an adjacent pulling group.

8. An apparatus for combining a plurality of printing material webs to form a multi-layer strand, comprising:
a first deflection roll, wherein an uppermost web of the multi-layer strand is deflected over the first deflection roll; and
a second deflection roll, wherein a lowest web of the multi-layer strand is deflected over the second deflection roll;
wherein the first and second deflection rolls are driven.

9. The apparatus according to claim 8, wherein the uppermost web and the lowest web are printed in multiple colors.

10. The apparatus according to claim 8, wherein a tension of the uppermost web and the lowest web is increased by the first and second deflection rolls, respectively.

11. The apparatus according to claim 8, wherein the uppermost web and the lowest web wrap around the first and second deflection rolls, respectively, by an angle of at least 60°.

12. The apparatus according to claim 8, wherein the first deflection roll is driven by a first motor and wherein the second deflection roll is driven by a second motor.

13. The apparatus according to claim 8, wherein the first deflection roll and the second deflection roll are connected by a belt drive and wherein a motor drives the belt drive.

14. The apparatus according to claim 8, further comprising:
a driven pulling group; and
a driven cutting group;
wherein the first deflection roll, the second deflection roll, the pulling group, and the cutting group are connected by a belt drive and wherein a motor drives the belt drive.

15. The apparatus according to claim 14, wherein a driven speed of the first and second deflection rolls is different from a driven speed of the pulling group and the cutting group.

16. A method for combining a plurality of printing material webs to form a multi-layer strand, comprising the steps of:
deflecting an uppermost web of the multi-layer strand over a first deflection roll;
deflecting a lowest web of the multi-layer strand over a second deflection roll; and
driving the first and second deflection rolls.

17. The method according to claim 16, wherein a tension of the uppermost web and the lowest web is increased by the step of driving the first and second deflection rolls, respectively.

18. The method according to claim 16, wherein the first deflection roll and the second deflection roll are connected by a belt drive and wherein a motor drives the belt drive.

19. The method according to claim 16, further comprising the steps of:
driving a pulling group; and
driving a cutting group;
wherein the first deflection roll, the second deflection roll, the pulling group, and the cutting group are connected by a belt drive and wherein a motor drives the belt drive.

20. The method according to claim 19, wherein a driven speed of the first and second deflection rolls is different from a driven speed of the pulling group and the cutting group.
